(19) United States
(12) Patent Application Publication
(10) Pub. No.: US 2010/0330247 A1
(43) Pub. Date: Dec. 30, 2010

(54) FOAMED CANDY

(76) Inventors: Nathalie Montaigne, Linselles (FR); Patrice Demeulemeester, Linselles (FR); Sylvie Lagache, Marcq en Baroeul (FR)

Correspondence Address: CANTOR COLBURN LLP, 20 Church Street, 22nd Floor, Hartford, CT, 06103, US

(21) Appl. No.: 12/677,949

(22) PCT Filed: Mar. 20, 2008
(86) PCT No.: PCT/GB2008/001089

§ 371 Date: Sep. 15, 2010

(30) Foreign Application Priority Data
Mar. 23, 2007 (GB) 0705610.4
Oct. 23, 2007 (GB) 0721041.2

(51) Int. Cl. A23G 3/52

(52) U.S. Cl. 426/572

(57) ABSTRACT

The present invention provides foamed candy compositions and methods for making foamed candy compositions. The foamed candy composition comprises a foam which comprises a sugar or a sugar substitute, a structuring agent and a fat or acid, and is characterised in that the fat or acid is associated with a carrier material. Examples include foamed candies comprising spray dried fruit powder, encapsulated malic acid, cocoa powder or chocolate crumb.

The present invention relates to foamed candy and processes for making such compositions. Particularly, the present invention relates to a foamed candy comprising fat and/or acid such that the composition has pleasant organoleptic/texture properties.

Aerated compositions, such as marshmallows or foamed candy are known in the art. While there are many types of foamed candy on the market, their methods of preparation generally fall into two main process groups: extruded foamed candy and deposited foamed candy. In both groups, the foamed candy is made up of two main ingredients: a sugar (or sugar substitute) based syrup and a structuring agent, usually gelatin, pectin, albumin, egg white, or agar. Typically, the sugar-based syrup is heated to reduce its water content and is thereafter cooled down. It is then combined with the structuring agent to form a slurry. The slurry is further aerated to form a foam. Optionally, colours and flavours can be added to the foam. Once the foam is produced, it can be shaped by an extrusion process or a deposition process. In the extrusion process, the foam is extruded through a die to form a rope. The die imparts the desired peripheral shape to the extruded rope. The rope is allowed to rest briefly to set, and then is cut into desired sizes. In the deposition process, the foam is deposited and allowed to rest briefly before shaping. Optionally, the extruded/deposited marshmallows can be dried. Foamed candy may also contain edible colouring and other minor edible ingredients such as edible humectants. However, foamed candy is mostly a sugar or sugar substitute based confection. The fat and/or acid content is usually very low if present at all.

It would be desirable to incorporate fat and/or acid into foamed candy in order to alter the organoleptic and/or texture properties of the candy. Fats and acids are incorporated into other types of confectionery and provide distinctive characteristics. Fats such as cocoa butter are present in chocolate and provide a sense of indulgence for the consumer. Acids such as citric acid may be added to jelly sweets to provide a tangy or sour sensation. Unfortunately the addition of fats or acids to foamed confectionery is very difficult due to adverse effects on the network that is provided by the structuring agent. The reasons for such adverse effects are not clearly known. If fat is present in a slurry of sugar-based syrup and structuring agent, the slurry cannot be successfully aerated to form a foam because the foam collapses, resulting in phase separation. Fat can sometimes be added after the slurry has been aerated; this provides a mousse like product. However, this may not provide a suitable foamed confectionery because the fat is readily oxidised (becomes rancid). This means that the shelf life of the product is very short and unsuitable for the confectionery market.

It is an object of the present invention to provide an improved foam candy composition and a process for preparing such a foamed candy composition.

According to a first aspect of the present invention there is provided a foamed candy composition comprising a foam, wherein the foam comprises a sugar or a sugar substitute, a structuring agent and a fat or acid, characterised in that, the fat or acid is associated with a carrier material.

According to a second aspect of the present invention, there is provided a process for preparing a foamed candy composition comprising the following steps:
(a) cooking a sugar or sugar substitute based syrup to obtain a desired dry solid (DS) content;
(b) adding a structuring agent to the sugar or sugar substitute based syrup to form a slurry;
(c) adding a fat or acid that is associated with a carrier material to the sugar or sugar substitute based syrup;
(d) aerating the slurry to form a foamed candy composition; and
(e) shaping the foamed candy composition.

In the context of the present invention ‘associated with a carrier material’ means intimately mixed with, encapsulated by, adsorbed onto or otherwise bound to the carrier material. Though not wishing to be bound by theory, the inventors propose that the carrier material masks the reactivity of the fat/acid and thereby hinders interaction between the fat/acid and the network provided by the structuring agent.

In one embodiment where the foamed candy comprises acid, the acid may be encapsulated by the carrier material. For example, the acid may be spray dried with the carrier material (e.g. a carbohydrate such as maltodextrin). Spray dried fruit powder comprises encapsulated fruit acid (e.g. citric acid).

In one embodiment where the foamed candy comprises fat, the fat may be intimately mixed with the carrier material. For example, cocoa powder comprises cocoa butter intimately mixed with the other cocoa solids and chocolate crumb comprises cocoa butter and milk fat intimately mixed with other ingredients (cocoa solids, sucrose and milk solids). In an alternative embodiment, the fat may be adsorbed onto the carrier material. For example, palm oil may be adsorbed onto a sweetener such as sucrose.

The fat or acid may be associated with one or more carrier materials. In one embodiment of the invention, the fat or acid, which is associated with a first carrier material, is intimately mixed with a second (or subsequent) carrier material. The second carrier material may be the same as or different from the first carrier material. In one embodiment the second carrier material is a sweetener such as sucrose. For example, cocoa powder (which comprises cocoa butter intimately mixed with the other cocoa solids serving as the first carrier material) may be intimately mixed with a sweetener such as sucrose and chocolate crumb (which comprises cocoa butter and milk fat intimately mixed with other ingredients) may be intimately mixed with a sweetener such as sucrose. As another example, a spray dried fruit powder (comprising fruit acid encapsulated by a first carrier material) may be intimately mixed with a sweetener such as sucrose.

Alternative sugars and sugar substitutes, alone or in combination with intense sweeteners may also be employed as carrier materials or second (or subsequent) carrier materials. In one embodiment a low-calorie foamed candy is provided in which the carrier material is one or more alternative sugars or a sugar substitutes, alone or in combination with intense sweeteners. Alternative sugars include fructose, dextrose, isomaltulose and trehalose. Potential sugar substitutes include sugar alcohols such as xylitol, sorbitol, maltitol, isomalt, polyglycitol, lactitol, mannitol and erythritol, low calorie sugar replacers such as polydextrose, tagatose, inulin, dextrin including wheat dextrin or maize dextrin or fructo-oligosaccharides, or any combination of the above. It may be desirable to include intense sweeteners such as saccharin, aspartame, sucralose, neotame, acesulfame-K, stevia or cyclamate in combination with the sugar substitute(s) to deliver an acceptable sweetness intensity.

The carrier material may be a particulate carrier material. The carrier material may be finely divided. One suitable carrier material has a d90 value from 1.5 μm to 1000 μm, or from 5 μm to 500 μm, or from 10 to 200 μm or from 15 μm to 100 μm.

When sucrose is employed as the carrier material, options include powdered sugar, icing sugar and fine sugar such as Silk Sugar® (British Sugar).

The carrier material may be mixed with a solvent such as water to form a solution, slurry, dispersion or paste. In one embodiment, the resulting mixture has a dry solid (DS) content of at least 60 wt %, or at least 80 wt %.

The carrier material is thought to hinder interaction between the fat/acid and the network provided by the structuring agent. In general, the more carrier material that is present, the more effective it will be at preventing such interaction but a large amount of carrier material may have adverse effects on the resulting product, for example, it may adversely affect the texture. In one series of embodiments the ratio of carrier material to fat/acid is at least 1:1, at least 3:1, at least 5:1 or at least 10:1. In another series of embodiments the ratio of carrier material to fat/acid is no more than 10:1, no more than 5:1, no more than 3:1 or no more than 1:1.

The sugar or sugar substitute may be a sugar or sugar substitute based syrup or derived from a sugar or sugar substitute based syrup. The sugar or sugar substitute may be glucose, sucrose, fructose or sugar alcohols such as sorbitol, erythritol, xylitol, maltitol, isomalt or any combination thereof. In one embodiment, the sugar or sugar substitute is glucose.

The sugar or sugar substitute based syrup may comprise glucose, sucrose, fructose or sugar alcohols such as sorbitol, erythritol, xylitol, maltitol, isomalt or any combination thereof. In one embodiment the sugar or sugar substitute based syrup comprises glucose.

The structuring agent may be gelatin, pectin, starch or a natural gum such as agar, alginate, carageenan, ghatti and xanthan. In one embodiment, the structuring agent is either gelatin or pectin.

The fat may be a vegetable fat or an animal fat. In one embodiment the fat is selected from the group consisting of coconut oil, hazelnut oil, palm oil, sunflower oil, corn oil, cottonseed oil, cocoa butter, and milk fat. In one series of embodiments the fat constitutes at least 0.5 wt % of the foamed candy composition, at least 1 wt %, at least 2 wt % or at least 5 wt %. In a further series of embodiments the fat constitutes no more than 10 wt %, no more than 8 wt % or no more than 7 wt % of the foamed candy composition.

In one embodiment the foam comprises from 2 to 8 (dry) wt % palm oil that is associated with sucrose and/or nutriose as the carrier material.

The fat may be provided in the form of cocoa powder. In one series of embodiments where the fat is provided in the form of cocoa powder, cocoa powder constitutes at least 2 wt % and no more than 50 wt % of the foamed candy, at least 5 wt % and no more than 30 wt % of the foamed candy or at least 8 wt % and no more than 25 wt % of the foamed candy.

The fat may be provided in the form of chocolate crumb. In one series of embodiments where fat is provided in the form of chocolate crumb, chocolate crumb constitutes at least 5 wt % and no more than 50 wt % of the foamed candy, at least 20 wt % and no more than 45 wt % of the foamed candy or at least 34 wt % and no more than 40 wt % of the foamed candy.

The acid may be a fruit acid. Such fruit acids include citric and malic acid. In one series of embodiments the acid constitutes at least 0.1 wt % of the foamed candy composition, at least 0.3 wt % or at least 0.5 wt %. In a further series of embodiments the acid constitutes no more than 2 wt % of the foamed candy composition, no more than 1.5 wt % or no more than 1.2 wt % of the foamed candy composition.

In one embodiment the foam comprises from 8 to 10 (dry) wt % spray dried fruit powder that is associated with sucrose as the carrier material. In a further embodiment, the foam comprises from 0.3 to 0.7 (dry) wt % citric acid and/or malic acid that is associated with sucrose as the carrier material.

In step (a) of the process the sugar or sugar substitute based syrup is cooked to evaporate water from the syrup and thereby provide the desired dry solid (DS) content. The dry solid content may be measured by weighing the syrup before and after cooking. In one series of embodiments the sugar or sugar substitute based syrup is cooked to a dry solid (DS) content of between 70 and 90 wt %, between 76 wt % and 86 wt % or between 78 wt % and 82 wt %.

The addition of structuring agent in step (b) may be carried out at a first pre-determined temperature. This temperature may be dependent on the nature of the structuring agent. For example, gelatin should not be added at a temperature greater than about 90° C. The first predetermined temperature may be at least 65° C. or at least 70° C. In one embodiment the first predetermined temperature is no more than 100° C., or no more than 90° C.

The addition of fat or acid that is associated with a carrier material in step (c) may be carried out at a second predetermined temperature. This second predetermined temperature may be dependent on the nature of the fat or acid. The second predetermined temperature may be at least 25° C., at least 35° C. or at least 45° C. The second predetermined temperature may be no more than 70° C., no more than 50° C. or no more than 35° C.

In step (d) the slurry may be aerated using standard equipment. On a small scale a laboratory mixer such as a Hobart mixer may be employed but when the process is carried out at a commercial scale a Mondomix mixer would be more practical. The aeration of the slurry in step (d) is may be carried out at a third predetermined temperature. The third predetermined temperature may be at least 30° C., at least 50° C. or at least 65° C. The third predetermined temperature may be no more than 90° C., no more than 70° C., no more than 50° C. or no more than 40° C.

Under normal circumstances the first predetermined temperature of step (b) will be greater than the third predetermined temperature of step (d). i.e. the slurry may be mixed and cooled before aeration.

In step (e) of the process the foamed candy composition may be shaped by starch deposition or by extrusion. The method of shaping the foamed composition may depend on the product required. Extrusion tends to result in a product with lower density than a product shaped by deposition.

Step (c) may be performed before or after step (b), or before or after step (d). In one embodiment the fat or acid is added before the slurry is aerated so that the process steps are carried out in the order (a), (b), (c), (d), (e), or (a), (c), (b), (d), (e). In particular, the fat or acid may be added between step (b) and step (d) so that the process steps are carried out in the order (a), (b), (c), (d), (e). This is advantageous for fats or acids that are temperature sensitive because they are then subjected to a lower temperature. In one embodiment, where the fats or acids are temperature sensitive, the fat or acid may be added after aeration (step (d)). Alternatively step (c) may be carried out at the same time as step (a), (b), (d) or (e). Some embodiments of this process are shown in Schemes 1a, 1b and 1c below.

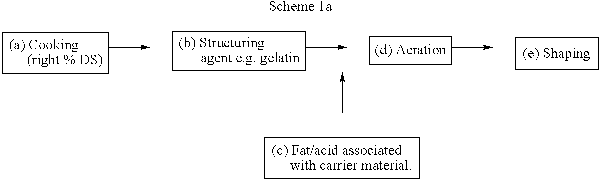

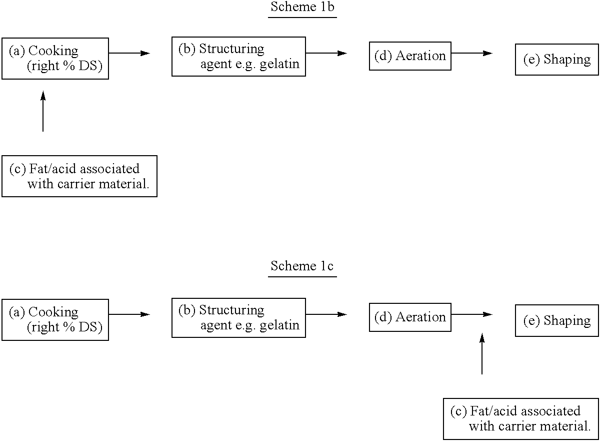

Embodiments of the invention will now be described by way of example only with reference to the accompanying figures in which:—

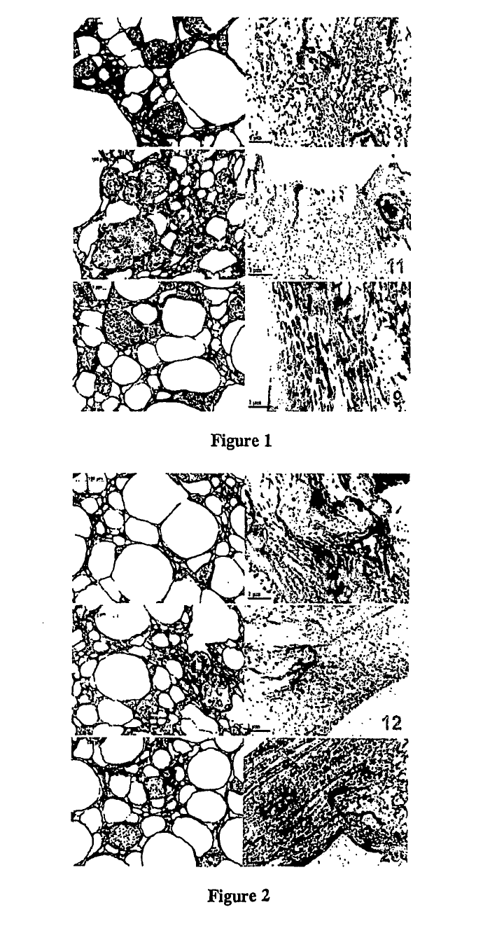

FIG. 1 shows microscopy images of a foamed candy comprising raspberry fruit powder (acid) in accordance with the invention. The magnification of the image is indicated by a line; for those images in the left column the line represents 100 μm and for those in the right column the line represents 1 μm.

FIG. 2 shows microscopy images of a foamed candy comprising raspberry and lemon fruit powders (acids) in accordance with the invention. The magnification of the image is indicated by a line; for those images in the left column the line represents 100 μm and for those in the right column the line represents 1 μm.

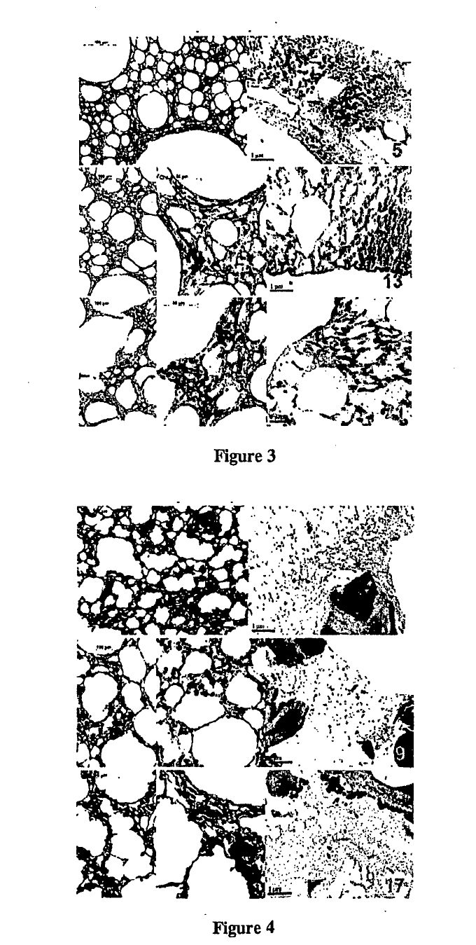

FIG. 3 shows microscopy images of a foamed candy comprising palm oil (fat) in accordance with the invention. The magnification of the image is indicated by a line; for those images in the left column the line represents 100 μm, for those in the middle column the line represents 50 μm and for those in the right column the line represents 1 μm.

FIG. 4 shows microscopy images of a foamed candy comprising cocoa powder (fat) in accordance with the invention. The magnification of the image is indicated by a line; for those images in the left column the line represents 100 μm, for those in the middle column the line represents 50 μm and for those in the right column the line represents 1 μm.

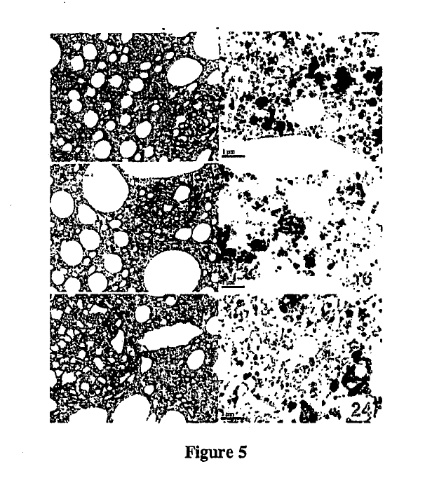

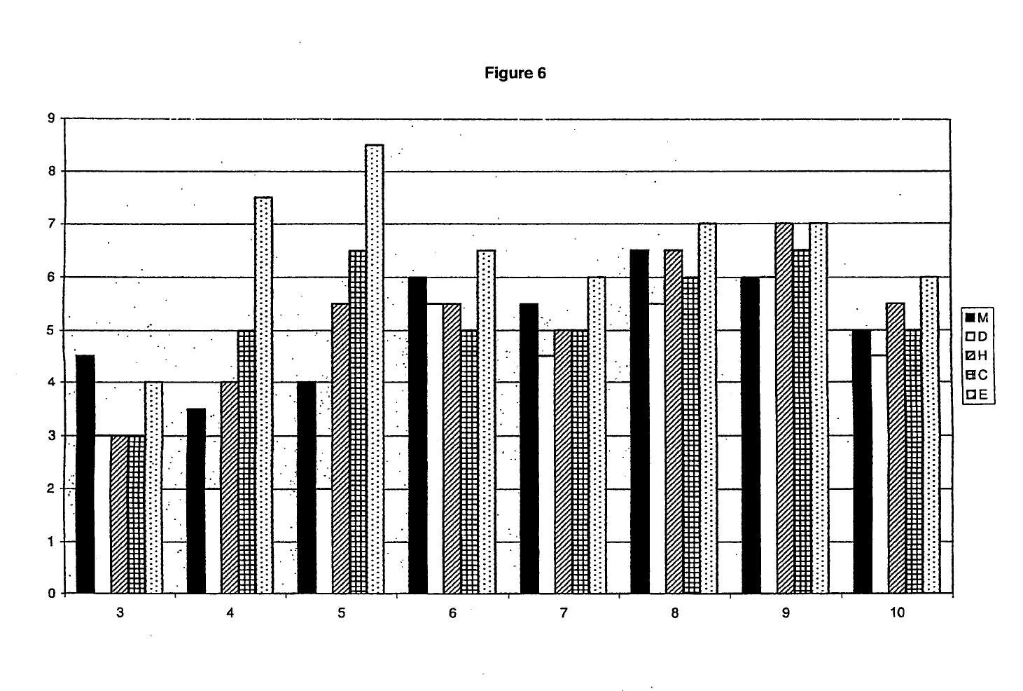

FIG. 5 shows microscopy images of a foamed candy comprising chocolate crumb (fat) in accordance with the invention. The magnification of the image is indicated by a line; for those images in the left column the line represents 100 μm and for those in the right column the line represents 1 μm.

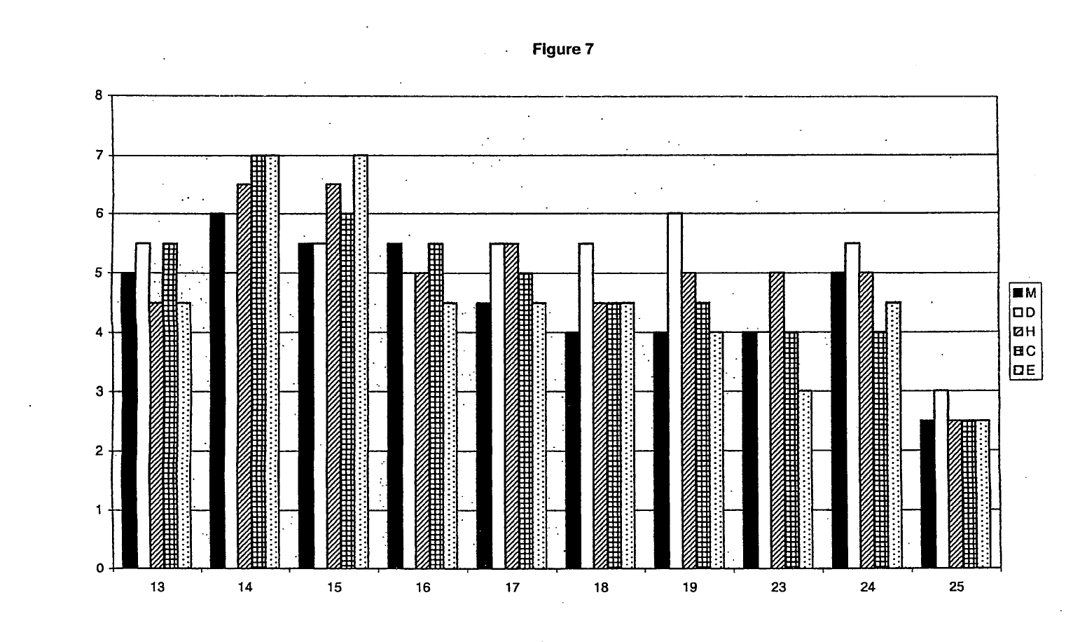

FIGS. 6 and 7 show bar charts to demonstrate properties of foamed candies.

### METHODOLOGY

### Method 1

### Laboratory Scale Using A Hobart Mixer

Syrup ingredients (e.g. sucrose, glucose, maltitol etc.) were poured into a pan and heated on an induction plate to provide a syrup having a desired dry solids (D.S) content. The syrup was then cooled to around 90° C., and structuring agent (e.g. gelatin) and flavour were added with mixing to form a slurry at 75° C. The slurry was transferred to a Hobart mixer that had been stored at 50° C. and aerated to form a foam, generally by whipping for 30 s in position 2 (medium speed) and a further 3 minutes in position 3 (high speed). (Alternatively, aeration could take place in a Hobart mixer that is jacketed to maintain the temperature, e.g. at around 30 to 35° C.) The density was measured and then the foamed composition was shaped by deposition onto greaseproof paper that had been dusted with starch. Additional ingredients (e.g. acid, fat, sugar etc.) were added after the addition of structuring agent and flavour but before aeration (scheme 1a), during cooking of the syrup (scheme 1b) or between aeration and shaping (scheme 1c).

### Method 2

### Pilot Plant Scale Using a Mondomix Aerator

The syrup ingredients were poured into a Rayneri cooker and heated (cooked up) to the desired DS content (checked by refractometer). The syrup was then allowed to cool to around 90° C. and structuring agent (e.g. gelatin) and flavour were added with mixing to form a slurry. The slurry was transferred to a bucket and then to the Mondomix hopper and whipped. The density was measured and then the foamed composition was shaped by deposition onto greaseproof paper that had been dusted with starch. Additional ingredients (e.g. fat, acid etc.) were either added to the slurry before aeration (scheme 1a) or after aeration but before shaping (scheme 1c) by connecting a pump at the mallow outflow.

### Ingredients

The ingredients used in the examples are listed in table 1 below.

TABLE 1

| | | DS content |
|---|---|---|
| | | (wt %) of |
| | | ingredient |
| Syrup | Sucrose | 100 |
| Ingredients | Glucose syrup 47DE | 79 |
| | Distilled water | 0 |
| | Nevuline (inverted sugar) | 80 |
| | Erythritol | 96 |
| | Maltitol | 100 |
| | Polydextrose | 96 |
| | Fructose syrup C*1751 | 82 |
| Structuring | 40% gelatin solution 125 bloom | 40 |
| agent | 33.8% gelatin 125 bloom | 33.8 |
| Vanilla | Vanilla Prova flavouring | 100 |
| flavouring | | |
| Additional | Sucrose (Silk Sugar ® sold by British | 100 |
| ingredients | Sugar (size distribution: d10 = 1.3 μm, | |
| | d50 = 8.2 μm, d90 = 18.5 μm)) | |
| | Nutriose ® (A dextrin sold by | 96 |
| | Roquette Fréres) | |
| | Sucrose solution | 67 |
| | Anhydrous citric acid | 100 |
| | Raspberry powder (Spray dried: 50 wt % | 100 |
| | dried fruit matter and 50 wt % | |
| | maltodextrin. Equivalent to 5.2 to | |
| | 8 wt % monohydrated citric acid.) | |
| | Aqueous raspberry mix | 80 |
| | Lemon powder (Spray dried: 40 wt % | 100 |
| | dried fruit matter and 60 wt % | |
| | maltodextrin. Equivalent to 22.4 to | |
| | 28 wt % monohydrated citric acid.) | |
| | Encapsulated malic acid (Encapsulated | 100 |
| | with 10% fat) | |
| | Palm oil | 100 |
| | Lecithin (Emulsifier) | 100 |
| | 10/12 cocoa powder (10-12 wt % fat, | 100 |
| | supplied by Barry Callebaut) | |
| | Chocolate crumb (Sucrose (57.45 wt %), | 100 |
| | fat free milk solids (20.3 wt %), milk | |
| | fat (8.36 wt %), fat free cocoa solids | |
| | (5.78 wt %) and cocoa fat (8.10 wt %). | |

### Comparative Example 1

### Standard Foamed Candy

A standard mallow (Comp. Ex. 1) was prepared using method 1 and the ingredients listed in table 2 below.

TABLE 2

| | | | | DS content |
|---|---|---|---|---|
| | | Mass | Mass of Dry | obtained after |
| | | (g) | Solids (g) | cooking up |
| Syrup | Sucrose | 190 | 190 | |
| Ingredients | Glucose syrup 47DE | 200 | 158 | |
| | Distilled water | 60 | 0 | |
| | Nevuline (inverted | 46 | 36.8 | |
| | sugar) | | | |
| | TOTAL (before | 496 | 384.8 | |
| | cooking up) | | | |
| | Mass lost due to | 35 | | |
| | evaporation | | | |
| | TOTAL (after | 461 | 384.8 | 83.5 wt % |
| | cooking up) | | | |
| Structuring | 40% gelatin solution | 40 | 16 | |
| agent | 125 Bloom | | | |
| Vanilla | Vanilla Prova | 1 | 1 | |
| flavouring | flavouring | | | |

The product has a good mallow texture, good melting, and is neither too chewy nor too spongy. The product has a density of 0.4 g/cm³, a water activity (Aw) of 0.55 (average of 3 samples) and a water content of 14-18%.

### Comparative Example 2

### Standard Foamed Candy

A foamed candy (Comp. Ex. 2) was prepared using method 1 and scheme 1a (except that the foamed composition was extruded rather than deposited). Sucrose (without acid or fat) was added to the slurry before aeration.

TABLE 3

| | | | | DS content (wt %) |
|---|---|---|---|---|
| | | Mass | Mass of Dry | obtained after |
| | | (g) | Solids (g) | cooking up |
| Syrup | Sucrose | 95 | 95 | |
| ingredients | Glucose syrup 47DE | 200 | 158 | |
| | Distilled water | 60 | 0 | |
| | Nevuline (invert | 46 | 36.8 | |
| | syrup) | | | |
| | TOTAL mass (before | 401 | 289.8 | |
| | cooking up) | | | |
| | Mass lost due to | 35 | | |
| | evaporation | | | |
| | TOTAL (after | 366 | 289.8 | 79.2 |
| | cooking up) | | | |
| Structuring | 40% gelatin solution | 40 | 16 | |
| agent | 125 Bloom | | | |
| Vanilla | Vanilla Prova | 1 | | |
| flavouring | flavouring | | | |
| Additional | Sucrose | 95 | 95 | |
| ingredients | | | | |

The marshmallow is white, sweet and bouncy with a density in the range of 0.2-0.3 g/cm³. It has an elastic chewy texture and good melting properties. It is neither shiny nor sticky.

### Comparative Example 3

### Standard Foamed Candy Comprising Citric Acid

The process of Comp. Ex. 1 was repeated except that 1.3 g citric acid (55% dry solids, pH 3.1) was added after the gelatin and vanilla flavouring but before aeration.

The resulting foamed candy (Comp. Ex. 3) comprises 0.17 wt % citric acid (based on the monohydrated acid), and a density of 0.42 g/cm³. However it is unstable and becomes sticky over time. Microscopy images show that phase separation had clearly taken place within 8 days, leading to collapse of the network.

### EXAMPLES 1 to 3

Foamed candy comprising 10 wt % spray dried fruit powder (acid) prepared in accordance with the present invention.

TABLE 5

| | | Ex. 1 | | Ex. 2 | | Ex. 3 | |
|---|---|---|---|---|---|---|---|
| Syrup | Sucrose | 95 | g | 95 | g | 108.2 | g |
| ingredients | Glucose syrup 47DE | 200 | g | 200 | g | 281.6 | g |
| | Distilled water | 60 | g | 60 | g | 42.6 | g |
| | Fructose syrup C*1751 | 50 | g | 50 | g | 46.5 | g |
| | TOTAL (before cooking up) | 405 | g | 405 | g | 478.9 | g |
| | Mass lost due | 25 | g | 25 | g | 54.2 | g |
| | to evaporation. | | | | | | |
| | TOTAL (after cooking up) | 380 | g | 380 | g | 424.7 | g |
| | DS content obtained | 77.4 | wt % | 77.4 | wt % | 86.8 | wt % |
| | after cooking up | | | | | | |

| Structuring | 40% gelatin | 45.5 | g | 45.5 | g | 48.6 |
|---|---|---|---|---|---|---|
| agent | 125 bloom solution | | | | | |
| Vanilla | Prova flavouring | 1 | g | 1 | g | 1 |
| flavouring | | | | | | |
| Additional | Sucrose | 95 | g | 95 | g | 0 |
| ingredients. | 67 wt % sucrose solution | 0 | | 0 | | 60 |
| | Spray dried raspberry | 45.5 | g | 36.4 | g | 47.7 |
| | fruit powder | | | | | |

| | | | |
|---|---|---|---|
| Spray dried lemon | 0 | 9.1 | 0 |
| fruit powder | | | |

Foamed candies comprising either 10 wt % raspberry fruit powder (Ex. 1) or 8 wt % raspberry/2 wt % lemon fruit powder (Ex. 2) were prepared using method 1 and the process shown in scheme 1a (above). The encapsulated acid was intimately mixed with sucrose (second carrier material). A foamed candy comprising 10 wt % raspberry fruit powder (Ex. 3) was prepared using method 1 and the process shown in scheme 1c. The encapsulated acid was mixed with a sucrose solution and mixed into the foamed composition before shaping. The properties of the foamed candies are summarised in table 6 below.

TABLE 6

| | Ex. 1 | Ex. 2 | Ex. 3 |
|---|---|---|---|
| Density (g/cm³) | 0.43 | 0.43 | 0.54 |
| Acid level | 0.66% | 1.03% | 0.66% |
| equivalent | | | |
| Water activity | 0.68 | 0.66 | Not |
| (average of | (good microbio- | (good microbio- | measured |
| 3 samples) | logical stability) | logical stability) | |

Microscopy images (FIG. 1) of Ex. 1 (10 wt % raspberry powder) were taken over a period of 3 weeks (on days 3, 11 and 19) and show that the gelatin network is very similar to the network in a standard foamed candy There is good aeration and the gelatin network is stable; the fruit powder does not hydrate and the gelatin network does not collapse. This is in contrast to Comp. Ex. 3 which comprises just 0.17 wt % citric acid but is unstable. The slightly chewy texture is similar to a standard deposited foamed candy (e.g. Comparative example 1). The foamed candy has a pleasant natural taste.

Microscopy images (FIG. 2) of Ex. 2 (8 wt % raspberry powder and 2 wt % lemon powder) were taken over a period of three weeks (on days 4, 12 and 20) and show the foamed candy to have good aeration and a stable network that is similar to that of a standard foamed candy. This is in marked contrast to the product obtained in Comparative example 3 which is unstable despite containing just 0.17 wt % acid. Ex. 1 is similar to Ex. 2 and has a pleasant natural taste.

### EXAMPLES 4 and 5

Foamed candy comprising aqueous raspberry mix in accordance with the invention.

TABLE 7

| | | Ex. 4 | | Ex. 5 | |
|---|---|---|---|---|---|
| Syrup | Sucrose | 13.34 | kg | 13.34 | kg |
| ingredients | Glucose syrup 47DE | 25.35 | kg | 25.35 | kg |
| | Distilled water | 4.5 | | 4.5 | |
| | Fructose syrup C*1751 | 4.19 | kg | 4.19 | kg |
| | TOTAL (before cooking up) | 47.38 | | 47.38 | |
| | Mass lost due to evaporation. | 3.47 | | 3.47 | |
| | TOTAL (after cooking up) | 43.91 | kg | 43.91 | kg |
| | DS content obtained | 83.64 | | 83.64 | |
| | after cooking up | | | | |
| Structuring | 40% gelatin | 4.28 | kg | 4.28 | kg |
| agent | 125 bloom solution | | | | |
| Vanilla | Prova flavouring | 0.09 | kg | 0.09 | kg |
| flavouring | | | | | |
| Additional | Aqueous raspberry mix | 5.49 | kg | 5.49 | kg |
| ingredients | | | | | |

Ex. 4 and Ex. 5 were prepared using the Mondomix method (Method 2). For Ex. 4 the aqueous raspberry mix was added to the slurry before aeration (scheme 1a). For Ex. 5 the aqueous raspberry mix was connected to the pump at the mallow outflow and the flow adjusted to have 80% foamed composition and 20% raspberry solution in a twist system. The properties of the foamed candies are summarised in table 8 below.

TABLE 8

| | Ex. 4 | Ex. 5 |
|---|---|---|
| Density (g/cm³) | 0.27 | 0.28 |
| Acid level | 0.66% | 0.66% |
| equivalent | | |
| Water activity | 0.58 | 0.60 |
| (average of | (good microbio- | (good microbio- |
| 3 samples) | logical stability) | logical stability) |

### EXAMPLES 6 to 9

Foamed candy comprising malic acid in accordance with the present invention.

TABLE 9

| | | Ex. 6 | | Ex. 7 | | Ex. 8 | | Ex. 9 | |
|---|---|---|---|---|---|---|---|---|---|
| Syrup ingredients | Sucrose | 80 | g | 80 | g | 160 | g | 120 | g |
| | Glucose syrup 47DE | 300 | g | 300 | g | 300 | g | 300 | g |
| | Distilled water | 50 | g | 50 | g | 50 | g | 50 | g |
| | Fructose syrup C*1751 | 43.2 | g | 43.2 | g | 43.2 | g | 43.2 | g |
| | TOTAL (before cooking up) | 473.2 | g | 473.2 | g | 553.2 | g | 513.2 | g |
| | Mass lost due to evaporation. | 48.8 | g | 48.8 | g | 48.8 | g | 69 | g |
| | TOTAL (after cooking up) | 424.4 | g | 424.4 | g | 504.4 | g | 444.2 | g |
| | DS content obtained after | 83.0 | wt % | 83.0 | wt % | 85.7 | wt % | 88.3 | wt % |
| | cooking up | | | | | | | | |
| Structuring agent | 40% gelatin 125 bloom solution | 45.6 | g | 45.6 | g | 45.6 | g | 45.6 | g |
| Vanilla flavouring | Vanilla Prova flavouring | 1 | g | 1 | g | 1 | g | 1 | g |
| Additional | Sucrose | 80 | g | 80 | g | 0 | | 0 | |
| ingredients | 67 wt % sucrose solution | 0 | | 0 | | 0 | | 60 | g |
| | Encapsulated malic acid | 0.95 | g | 2.28 | g | 2.28 | g | 2.28 | g |

Examples 6 to 9 were prepared using the Hobart method (Method 1). For Ex. 6 and Ex. 7, 0.2 wt % and 0.5 wt % of malic acid were intimately mixed with sucrose (second carrier material) and added to the slurry before aeration (scheme 1a). For Ex. 8 0.5 wt % encapsulated acid was added to the slurry before aeration without a second carrier material. For Ex. 9 0.5 wt % encapsulated acid was mixed with sucrose solution and added to the foamed composition before shaping (scheme 1c). The properties of examples 6 to 9 are summarised in table 10 below.

TABLE 10

| | Ex. 6 | Ex. 7 | Ex. 8 | Ex. 9 |
|---|---|---|---|---|
| Density (g/cm³) | 0.48 | 0.51 | 0.50 | 0.51 |
| Acid level | 0.18 | 0.45 | 0.45 | 0.45 |
| equivalence | | | | |
| Water activity | Not | 0.622 | 0.607 | 0.589 |
| (average of | measured | | | |
| 3 samples) | | | | |
| wt % H₂O | Not | 13.9 | 14.1 | 13.9 |
| | measured | | | |

### Example 10

Foamed comprising 0.5 wt % anhydrous citric acid.

TABLE 11

| | | Ex. 10 | |
|---|---|---|---|
| Syrup ingredients | Sucrose | 80 | g |
| | Glucose syrup 47DE | 300 | g |
| | Distilled water | 50 | g |
| | Fructose syrup C*1751 | 43.2 | g |
| | TOTAL (before cooking up) | 473.2 | g |
| | Mass lost due to evaporation. | 48.8 | g |
| | TOTAL (after cooking up) | 424.4 | g |
| | DS content obtained after cooking up | 83.0 | wt % |
| Structuring agent | 40% gelatin 125 bloom solution | 45.6 | g |
| Vanilla flavouring | Vanilla Prova flavouring | 1 | g |
| Additional | Sucrose | 80 | g |
| ingredients | Anhydrous citric acid | 2.28 | g |

A foamed candy comprising anhydrous citric acid was prepared using Method 1. The citric acid was intimately mixed with sucrose and added to the slurry before aeration (scheme 1a). The properties of the foamed candy are summarised in table 12 below.

TABLE 12

| | Ex. 10 (1a) |
|---|---|
| Density (g/cm³) | 0.48 |
| Acid level equivalent | 0.5% |
| Water activity (average of 3 samples) | 0.617 |
| wt % H₂O | 13.4 wt % |

### EXAMPLES 11 to 13

foamed candy comprising palm oil (fat) in accordance with the present invention.

TABLE 13

| | | Ex. 11 | | Ex. 12 | | Ex. 13 | |
|---|---|---|---|---|---|---|---|
| Syrup | Sucrose | 95 | g | 95 | g | 80 | g |
| ingredients | Glucose syrup 47DE | 200 | g | 200 | g | 300 | g |
| | Distilled water | 60 | g | 60 | g | 50 | g |
| | Fructose syrup C*1751 | 48.5 | g | 48.5 | g | 47 | g |
| | TOTAL (before cooking up) | 403.5 | g | 403.5 | g | 477 | g |
| | Mass lost due to evaporation. | 32.5 | g | 32.5 | g | 44 | g |
| | TOTAL (after cooking up) | 371 | g | 371 | g | 433 | |
| | DS content obtained after | 78.9 | wt % | 78.9 | wt % | 82.1 | wt % |
| | cooking up | | | | | | |
| Structuring | 40% gelatin 125 bloom | 41.5 | g | 41.5 | g | 48.6 | g |
| agent | solution | | | | | | |
| Vanilla | Vanilla Prova flavouring | 1 | g | 1 | g | 1 | g |
| flavouring | | | | | | | |
| Additional | Sucrose | 95 | g | 95 | g | 80 | g |
| ingredients | Palm oil | 8.3 | g | 8.3 | g | 29.1 | g |

| | | | | |
|---|---|---|---|---|
| Emulsifier (Sisterna) | 0 | 0.2 | g | 0 |

Foamed candies were prepared using Method 1 and the ingredients listed in table 13. The palm oil was pre-mixed with sucrose and added to the slurry before aeration (scheme 1a). The properties of the foamed candies are summarised in table 14 below.

TABLE 14

| | Ex. 11 (1a) | Ex. 12 (1a) | Ex. 13 (1a) |
|---|---|---|---|
| Density (g/cm³) | 0.45 | 0.56 | 0.56 |
| Fat (wt %) | 2 wt % | 2 wt % | 6 wt % |
| Water activity | 0.65 (good | 0.65 (good | 0.62 (good |
| (average of | microbiological | microbiological | microbiological |
| 3 samples) | stability) | stability) | stability) |

Microscopy images (FIG. 3) of Ex. 11 were taken over a period of three weeks (on days 5, 13 and 21) and show that the gelatin network is stable and that there is good air bubble distribution. Despite the presence of a fat the slurry is aerated to form a foam and the subsequent gelatin network is stable. We suggest that this is due to the fat being ‘bound’ to the sucrose so its interaction with the gelatin network is hindered. Both products have the texture of an aerated jelly but the product containing emulsifier is slightly denser than the product without emulsifier.

### EXAMPLES 14 to 17

Foamed candy comprising 2 wt % palm oil (fat) and 6 wt % dextrin (Nutriose®).

TABLE 15

| | | Ex. 14 | | Ex. 15 | | Ex. 16 | | Ex. 17 | |
|---|---|---|---|---|---|---|---|---|---|
| Syrup ingredients | Sucrose | 160 | g | 80 | g | 160 | g | 120 | g |
| | Glucose syrup 47DE | 300 | g | 300 | g | 300 | g | 240 | g |
| | Distilled water | 50 | g | 50 | g | 50 | g | 50 | g |
| | Fructose syrup C*1751 | 48 | g | 48 | g | 48 | g | 48.5 | g |
| | TOTAL (before cooking up) | 599 | g | 478 | g | 558 | g | 458.5 | g |
| | Mass lost due to evaporation. | 48 | g | 43.5 | g | 43.5 | g | 53.5 | g |
| | TOTAL (after cooking up) | 556 | g | 434.5 | g | 514.5 | g | 405.0 | g |
| | DS content obtained after | 85.6 | wt % | 82.0 | wt % | 84.8 | wt % | 86.3 | wt % |
| | cooking up | | | | | | | | |
| Structuring agent | 40% gelatin 125 bloom solution | 50 | g | 50 | g | 50 | g | 50 | g |
| Vanilla flavouring | Vanilla Prova flavouring | 1 | g | 1 | g | 1 | g | 1 | g |
| Additional | Sucrose | 0 | | 80 | g | 0 | | 0 | |
| ingredients | Palm oil | 10 | g | 10 | g | 10 | g | 10 | g |
| | Nutriose ® | 31 | g | 31 | g | 31 | g | 31 | g |
| | Glucose syrup 47DE | 0 | | 0 | | 0 | | 60 | g |
| | 80 wt % sucrose solution | 0 | | 0 | | 0 | | 50 | g |

Foamed candies were prepared using Method 1. In Ex. 14 the fat and Nutriose® were added to the pan together with the syrup ingredients (scheme 1b). In Ex. 15 the fat was pre-mixed with carrier materials (sucrose and Nutriose®) before being added to the slurry (scheme 1a). In Ex. 16 the fat was pre-mixed with a carrier material (Nutriose®) before being added to the slurry (scheme 1a). In Ex. 17 fat was mixed with a solution containing glucose, sucrose and Nutriose® and added to the foamed composition before shaping (scheme 1c). Properties of the resulting foamed candies are summarised in table 16 below.

TABLE 16

| | Ex. 14 | Ex. 15 | Ex. 16 | Ex. 17 |
|---|---|---|---|---|
| Density (g/cm³) | 0.54 g | 0.52 | 0.53 | 0.56 |
| Fat (wt %) | 2 | 2 | 2 | 2 |
| Water activity | Not | Not | 0.610 | Not |
| (average of | measured | measured | | measured |
| 3 samples) | | | | |
| wt % H₂O | Not | Not | 14.2 | Not |
| | measured | measured | | measured |

### EXAMPLES 18 and 19

Foamed candy comprising 2 wt % palm oil (fat) in accordance with the invention.

TABLE 17

| | | Ex. 18 | | Ex. 19 | |
|---|---|---|---|---|---|
| Syrup | Sucrose | 120 | g | 120 | g |
| ingredients | Glucose syrup 47DE | 300 | g | 240 | g |
| | Distilled water | 50 | g | 50 | g |
| | Fructose syrup C*1751 | 45 | g | 44 | g |
| | TOTAL (before cooking up) | 515 | g | 454 | g |
| | Mass lost due to evaporation. | 57 | g | 57 | g |
| | TOTAL (after cooking up) | 458 | g | 397 | g |
| | DS content obtained after | 86.0 | wt % | 87.1 | wt % |
| | cooking up | | | | |
| Structuring | 40% gelatin 125 bloom | 46.5 | g | 45.5 | g |
| agent | solution | | | | |
| Vanilla | Vanilla Prova flavouring | 1 | g | 1 | g |
| flavouring | | | | | |
| Additional | Sucrose | 0 | | 0 | |
| ingredients | Palm oil | 9.4 | g | 9.1 | g |
| | Glucose syrup 47DE | 0 | | 60 | g |
| | 80 wt % sucrose solution | 50 | g | 50 | g |

| | | | |
|---|---|---|---|
| Lecithin (emulsifier) | 0.6 | g | 0 |

Ex. 18 and Ex. 19 were made using the Hobart mixer method (Method 1). Fat was mixed with either a sucrose/lecithin solution (Ex. 18) or a sucrose/glucose solution (Ex. 19) and added to the foamed composition after whipping but before shaping (scheme 1c). The properties of Ex. 18 and Ex. 19 are summarised in table 18 below.

TABLE 18

| | Ex. 18 | Ex. 19 |
|---|---|---|
| Density (g/cm³) | 0.63 | 0.57 |
| Fat (wt %) | 2 | 2 |
| Water activity (average | Not measured | 0.609 |
| of 3 samples) | | |
| wt % H₂O | Not measured | 14 |

### EXAMPLES 20 to 22

foamed candy comprising cocoa powder (fat) with a second carrier material in accordance with the present invention.

TABLE 19

| | | Ex. 20 | | Ex. 21 | | Ex. 22 | |
|---|---|---|---|---|---|---|---|
| Syrup | Sucrose | 95 | g | 95 | g | 95 | g |
| ingredients | Glucose syrup 47DE | 200 | g | 200 | g | 200 | g |
| | Distilled water | 60 | g | 60 | g | 60 | g |
| | Fructose syrup C*1751 | 47.5 | g | 48.5 | g | 0 | |
| | Nevuline (invert sugar) | 0 | | 0 | | 46 | |
| | TOTAL | 402.5 | g | 403.5 | g | 401 | g |
| | Mass lost due to evaporation. | 28.5 | g | 27 | g | 17 | g |
| | TOTAL (after cooking up) | 374 | g | 376.5 | g | 384 | g |
| | DS content obtained after | 78.1 | wt % | 77.8 | wt % | 75.5 | wt % |
| | cooking up | | | | | | |
| Structuring | 40% gelatin 125 bloom | 43.5 | g | 44.5 | g | 49 | g |
| agent | solution | | | | | | |
| Vanilla | Vanilla Prova flavouring | 1 | g | 1 | g | 1 | g |
| flavouring | | | | | | | |
| Additional | Sucrose | 95 | g | 95 | g | 95 | g |
| ingredients | 10/12 cocoa powder | 26 | g | 35.5 | g | 89 | g |

Foamed candies comprising 6 dry wt % (Ex. 20), 8 dry wt % (Ex. 21) and 18 dry wt % (Ex. 22) 10/12 cocoa powder were prepared using the ingredients listed in table 19 and the Hobart method (Method 1). 10/12 cocoa powder comprises 10-12 wt % cocoa butter (fat) and 88-90 wt % non-fat cocoa solids (first carrier material). A dry mix of cocoa powder and sucrose (second carrier material) was added to the slurry before aeration (scheme 1a). Properties of the foamed candies are summarised in table 20 below.

TABLE 20

| | Ex. 20 (6 wt % | Ex. 21 (8 wt % | Ex. 22 (18 wt % |
|---|---|---|---|
| | cocoa powder) | cocoa powder) | cocoa powder) |
| Density (g/cm³) | 0.43 | 0.43 | 0.59 |
| Fat content | 0.66 | 0.88 | 2.00 |
| (wt %) | | | |
| Water activity | 0.67 | 0.67 | 0.61 |
| (average of | | | |
| 3 samples) | | | |

Ex 20 has an interesting sandy texture which melts quickly in the mouth. Ex. 21 has a texture similar to that of a standard foamed candy. Ex. 22 has a short texture, similar to that of nougat and good melting properties. All products appear stable over time.

Microscopy images (FIG. 4) were taken of Ex. 21 on days 8, 16 and 24. The gelatin network sets around the air bubbles and is stable over time even through the cocoa powder particles disturb the network.

### EXAMPLES 23 to 25

Foamed candy comprising cocoa powder (fat) without a second carrier material.

TABLE 21

| | | Ex. 23 | | Ex. 24 | | Ex. 25 | |
|---|---|---|---|---|---|---|---|
| Syrup | Sucrose | 136.2 | g | 136.2 | g | 11.57 | kg |
| ingredients | Glucose syrup 47DE | 258.7 | g | 258.7 | g | 21.99 | kg |
| | Distilled water | 50 | g | 67.2 | g | 5.71 | |
| | Fructose syrup C*1751 | 42 | g | 54.3 | g | 4.62 | kg |
| | TOTAL | 486.9 | g | 516.4 | g | 40.66 | kg |
| | Mass lost due to evaporation. | 43.5 | g | 52.6 | g | 3.23 | |
| | TOTAL (after cooking up) | 443.4 | g | 463.8 | g | 40.66 | |
| | DS content obtained after | 84.6 | wt % | 83.0 | wt % | 80.5% | |
| | cooking up | | | | | | |
| Structuring | 40 wt % gelatin 125 bloom | 42.7 | g | 49.8 | g | 4.23 | kg |
| agent | solution | | | | | | |
| Vanilla | Vanilla Prova flavouring | 0.9 | g | 1 | g | 0.085 | kg |
| flavouring | | | | | | | |
| | 10/12 cocoa powder (Barry Callebaut) | 34.2 | g | 89.3 | g | 7.59 | kg |

Ex. 23 and Ex. 24 were prepared using the Hobart method (Method 1). Ex. 25 was prepared using the Mondomix method (Method 2). For each of these examples, cocoa powder was added to the slurry before aeration (scheme 1a) and without pre-mixing with a second carrier material. Properties of the foamed candies are summarised in table 22 below.

TABLE 22

| | Ex. 23 (8 wt % | Ex. 24 (18 wt % | Ex. 25 (18 wt % |
|---|---|---|---|
| | cocoa powder) | cocoa powder) | cocoa powder) |
| Density (g/cm³) | 0.52 | 0.68 | 0.41 |
| Fat content | 0.88 | 1.98 | 1.98 |
| (wt %) | | | |
| Water activity | Not measured | Not measured | 0.648 |
| (average of | | | |
| 3 samples) | | | |
| wt % H₂O | Not measured | Not measured | 14.8 |

### EXAMPLES 26 and 27

Foamed candy comprising chocolate crumb (fat) in accordance with the present invention.

TABLE 23

| | | Ex. 26 | Ex. 27 |
|---|---|---|---|
| Syrup | Sucrose | 95 | 31 |
| ingredients | Glucose syrup 47DE | 200 | 200 |
| | Distilled water | 60 | 60 |
| | Fructose syrup C*1751 | 52.5 | 42 |
| | TOTAL (before cooking up) | 407.5 | 333 |
| | Mass lost due to evaporation | 20 | 34 |
| | TOTAL (after cooking up) | 387.5 | 299 |
| | DS content obtained after | 76.4 wt % | 74.73 wt % |
| | cooking up | | |
| Structuring | 40% gelatin 125 bloom | 48 | 40.5 |
| agent | solution | | |
| Vanilla | Vanilla Prova flavouring | 1 | 1 |
| flavouring | | | |
| Additional | Chocolate crumb | 165 | 160 |
| ingredients | | | |

Foamed candies comprising either 34 dry wt % (Ex. 26) or 40 dry wt % (Ex. 27) chocolate crumb were prepared using the ingredients listed in table 23 and the Hobart method (Method 1). The chocolate crumb contains sucrose (57.45 wt %), fat free milk solids (20.3 wt %), milk fat (8.36 wt %), fat free cocoa solids (5.78 wt %) and cocoa fat (8.10 wt %). The cocoa fat and milk fat is intimately mixed with the other ingredients (first carrier material). The chocolate crumb was added to the slurry before aeration (scheme 1a). The products have the following properties.

TABLE 24

| | Ex. 26 | Ex. 27 |
|---|---|---|
| Density (g/cm³) | 0.74 | 0.77 |
| Fat content (wt %) | 5.64 | 6.58 |
| Water activity (average of 3 samples) | 0.65 | 0.61 |

Both products were very stable over time. The texture in each case is similar to an aerated jelly with the crumb pieces providing an unusual crispy texture. There is also a strong creamy taste and good chewiness.

Microscopy images (FIG. 5) were taken of the Ex. 27 (40 wt % crumb product) on days 8, 16 and 24. The gelatin network sets around the air bubbles even though the larger crumb particles disturb the network.

### EXAMPLES 28 and 29

Sugar free foamed candies comprising malic (acid) in accordance with the invention.

TABLE 25

| | | Ex. 28 | | Ex. 29 | |
|---|---|---|---|---|---|
| Syrup | Polydextrose | 420 | g | 187.5 | g |
| ingredients | Erythritol | 187.5 | g | 0 | |
| | Maltitol | 0 | | 420 | g |
| | Distilled water | 152 | g | 152 | g |
| | TOTAL (before cooking up) | 759.5 | g | 795.5 | g |
| | Mass lost due to evaporation. | 52 | g | 52 | g |
| | TOTAL (after cooking up) | 707.5 | g | 707.5 | |
| | DS content obtained after | 82.4 | wt % | 84.8 | wt % |
| | cooking up | | | | |
| Structuring | 33.8% gelatin 125 bloom | 75 | g | 75 | g |
| agent | solution | | | | |
| Vanilla | Vanilla Prova flavouring | 1.65 | g | 1.65 | g |
| flavouring | | | | | |
| | Encapsulated malic acid | 3.95 | g | 3.95 | g |

Sugar free foamed candies comprising 0.5 wt % malic acid are prepared using erythritol and polydextrose (Ex. 28) or maltitol and polydextrose (Ex. 29) in place of sugar. The foamed candies are prepared using a Hobart mixer (Method 1) and the encapsulated acid is added to the slurry before aeration (scheme 1a). The resulting candies comprise the equivalent of 0.56% acid.

### EXAMPLES 30 and 31

Sugar free foamed candies comprising cocoa powder (fat) in accordance with the invention.

TABLE 26

| | | Ex. 30 | | Ex. 31 | |
|---|---|---|---|---|---|
| Syrup | Polydextrose | 420 | g | 187.5 | g |
| ingredients | Erythritol | 187.5 | g | 0 | |
| | Maltitol | 0 | | 420 | g |
| | Distilled water | 152 | g | 152 | g |
| | TOTAL (before cooking up) | 759.5 | g | 795.5 | g |
| | Mass lost due to evaporation. | 52 | g | 52 | g |
| | TOTAL (after cooking up) | 707.5 | g | 707.5 | |
| | DS content obtained after | 82.4 | wt % | 84.8 | wt % |
| | cooking up | | | | |
| Structuring | 33.8% gelatin 125 bloom | 75 | g | 75 | g |
| agent | solution | | | | |
| Vanilla | Vanilla Prova flavouring | 1.65 | g | 1.65 | g |
| flavouring | | | | | |
| | Cocoa powder | 68 | g | 68 | g |

Sugar free foamed candies comprising 8 wt % cocoa powder (dry weight) are prepared using erythritol and polydextrose (Ex. 30) or maltitol and polydextrose (Ex. 31) in place of sugar. The foamed candies are prepared using a Hobart mixer (Method 1) and the cocoa powder is added to the slurry before aeration (scheme 1a). The resulting candies comprise 0.88 wt % fat.

### Sensory Evaluation

Some of the foamed candies were evaluated using the following sensory terms:—

Melting (M): 0=quick melting, 10=slow melting.
Density (D): 0=aerated, 10=dense.
Hardness (H): 0=soft, 10=hard.
Chewiness (C): 0=soft, 10=strong.
Elasticity (E): 0=low, 10=high.

The results are shown in table 27 and also in FIG. 6 (foamed candies comprising acid) and FIG. 7 (foamed candies comprising fat).

TABLE 27

| Example | M | D | H | C | E |
|---|---|---|---|---|---|
| 3 | 4.5 | 3 | 3 | 3 | 4 |
| 4 | 3.5 | 2 | 4 | 5 | 7.5 |
| 5 | 4 | 2 | 5.5 | 6.5 | 8.5 |
| 6 | 6 | 5.5 | 5.5 | 5 | 6.5 |
| 7 | 5.5 | 4.5 | 5 | 5 | 6 |
| 8 | 6.5 | 5.5 | 6.5 | 6 | 7 |
| 9 | 6 | 6 | 7 | 6.5 | 7 |
| 10 | 5 | 4.5 | 5.5 | 5 | 6 |
| 13 | 5 | 5.5 | 4.5 | 5.5 | 4.5 |
| 14 | 6 | 5 | 6.5 | 7 | 7 |
| 15 | 5.5 | 5.5 | 6.5 | 6 | 7 |
| 16 | 5.5 | 5 | 5 | 5.5 | 4.5 |
| 17 | 4.5 | 5.5 | 5.5 | 5 | 4.5 |
| 18 | 4 | 5.5 | 4.5 | 4.5 | 4.5 |
| 19 | 4 | 6 | 5 | 4.5 | 4 |
| 23 | 4 | 4 | 5 | 4 | 3 |
| 24 | 5 | 5.5 | 5 | 4 | 4.5 |
| 25 | 2.5 | 3 | 2.5 | 2.5 | 2.5 |

1. A foamed candy composition comprising a foam, wherein the foam comprises a sugar or a sugar substitute, a structuring agent and a fat or acid, characterised in that, the fat or acid is associated with a carrier material.

2. The composition according to claim 1, comprising an acid.

3. The composition according to claim 2, wherein the acid is encapsulated by the carrier material.

4. The composition according to claim 3, wherein the acid encapsulated by the carrier material is constituted by spray dried fruit powder.

5. The composition according to claim 2, wherein the acid is citric acid.

6. The composition according to claim 2, having a total acid content of at least 0.5 wt %.

7. The composition according to claim 1 comprising a fat.

8. The composition according to claim 7, wherein the fat is intimately mixed with a carrier material.

9. The composition according to claim 8, wherein the fat intimately mixed with the carrier material is constituted by cocoa powder.

10. The composition according to claim 9, comprising at least 5 wt % cocoa powder.

11. The composition according to claim 8, wherein the fat intimately mixed with the carrier material is constituted by chocolate crumb.

12. The composition according to claim 7, wherein the fat is adsorbed onto a carrier material.

13. The composition according to claim 7, having a total fat content of at least 1 wt %.

14. The composition according to claim 1, wherein the structuring agent is gelatin, pectin, starch or a natural gum.

15. The composition according to claim 1, additionally comprising a second carrier material.

16. The composition according to claim 15, wherein the first or second carrier material is sucrose, an alternative sugar, a sugar substitute or any combination thereof.

17. The composition according to claim 15 wherein the carrier material and/or second carrier material is mixed with a solvent.

18. A process for preparing a foamed candy composition comprising:
(a) cooking a sugar or sugar substitute based syrup to obtain a desired dry solid (DS) content;
(b) adding a structuring agent to the sugar or sugar substitute based syrup to form a slurry;
(c) adding a fat or acid that is associated with a carrier material to the sugar or sugar substitute based syrup;
(d) aerating the slurry to form a foamed candy composition; and
(e) shaping the formed candy composition.

19. The process according to claim 18, wherein the process is carried out in the order (a), (b), (c), (d), (e), or (a), (c), (b), (d), (e).

20. The process according to claim 18, wherein the sugar or sugar substitute based syrup comprises glucose, sucrose, fructose, a sugar alcohol or a combination thereof.

21. The process according to claim 18, wherein the structuring agent is gelatin, pectin, starch or a natural gum.

22. The process according to claim 18, wherein the carrier material is sucrose, an alternative sugar or a sugar substitute.

23. The process according to claim 18, wherein the foamed candy composition is shaped by starch deposition or by extrusion.
